(19) United States
(12) Patent Application Publication
(10) Pub. No.: US 2019/0374810 A1
(43) Pub. Date: Dec. 12, 2019

(54) Support Seat Cushion for Exercise and Stretching

(71) Applicant: Hong Liu, Temecula, CA (US)

(72) Inventor: Hong Liu, Temecula, CA (US)

(21) Appl. No.: 16/004,171

(22) Filed: Jun. 8, 2018

(51) Int. Cl. A63B 21/00; A63B 24/00; A63B 71/00; A61H 7/00

(52) U.S. Cl. CPC A63B 21/4039; A63B 24/0062; A63B 71/0054; A61H 7/003; A61H 2201/1284; A63B 2213/007; A63B 2220/56; A63B 2225/64; A63B 2208/0228; A63B 2213/002

(57) ABSTRACT

The invention is an ergonomic support seat cushion, the top surface of which is uniquely shaped and which can be used for seated exercise, stretching and self-massage.

The cushion includes contours derived using the mathematical equations based in the Golden Ratio (φ) and certain proportions based in the Rule of Thirds. The size of the support cushion can be varied proportionally to the size of the person. The width shape of the device comes in different versions, each maintaining Golden Curves and Rule of Thirds proportions. The wider versions of the cushion have holes for the two Sitz bones in the pelvis. The support seat cushions for males versus females have differences to account for dimorphism of the pelvis. The unique dimensional curvatures of the invention can be incorporated within devices that have seats.

### BACKGROUND OF THE INVENTION

The invention pertains to the field of exercise devices. There are a number of body alignment and/or exercise systems based on human ergonomics in the market. These devices can be used to stretch, strengthen and/or massage which will thus realign the body and improve posture. Some of these products are designed to place a passive sitting pelvis or spine into a healthy posture. The purpose of those devices is to create comfortable positioning and prevent/ameliorate pain. Some body alignment systems have the purpose of actually reshaping a misaligned body structure. These systems may use traction, vibration, and pressure and/or require therapeutic exercise done with them. There are also acupressure mats that can improve alignment. These mats can involve self-massage inasmuch as a person can move their back upon the mat. Most body alignment devices and systems cannot be carried easily such as in a suitcase. Many are not acceptable for use while working in a workplace.

### SUMMARY OF THE INVENTION

The invention is an ergonomically supportive seat cushion, the top surface of which is uniquely shaped. The cushion can be used for seated exercise, stretching and self-massage. The ergonomic design and shape of the cushion include contours derived using the mathematical equations for the Golden Ratio (φ) and the Golden Curve (a segment of the Golden Spiral, which is derived from the Fibonacci sequence (FIG. 2). The size of the support cushion can be tailored by proportionally applying the mathematical equations. The width shape of the device comes in versions, each maintaining the Golden Curves proportions. The wider versions of the cushion have two complete holes (left and right, mirroring each other) into which the two Sitz bones of a human pelvis are to fit during sitting. The design of the cushion holes differs slightly in males versus females in order to account for sexual dimorphism. The exercise support cushion is constructed from a rigid or semi-rigid unspecified material. The cushion may incorporate inside it different materials; far-infrared material, magnets, heating elements, pressure sensors, other electronic devices and/or a top layer of softer material. A thin layer of softer material may be added on the top surface of the exercise support cushion to prevent discomfort in slender people. The contours of the surface of the cushion can be incorporated within larger seats, chairs or other devices that contain seats.

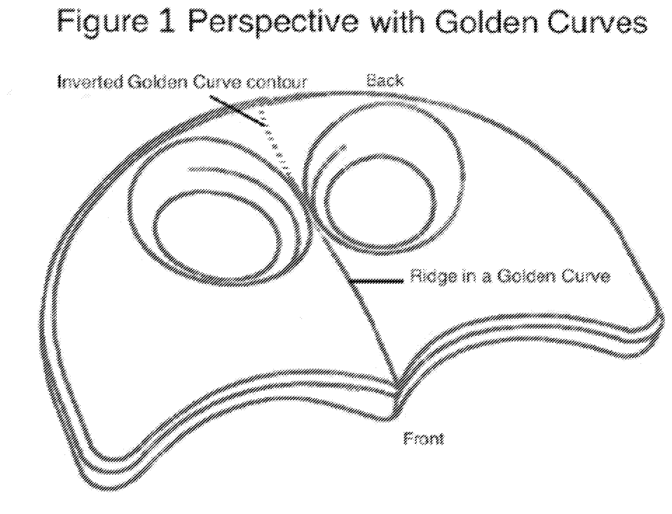

### DESCRIPTION OF FIG. 1

FIG. 1) Perspective view with Golden Curves

This figure shows that along the centerline of the top front of the invention is a convex ridge that is in the shape of a Golden Curve. The ridge is visibly noticeable when looking at a sample of the invention. The dotted line shows that there is a concave Golden Curve contour along the centerline back of the invention (this is not noticeable when you view a sample of the invention). These centerline contours also occur in the other versions of the invention.

### DETAILED DESCRIPTION OF THE INVENTION

The invention is an ergonomically supportive seat cushion. Some of the curved contours of its top surface are uniquely determined from application of the mathematical calculations of the Golden Ratio, Golden Spiral and the Golden Curve. The Golden Ratio, symbolized by phi or φ, is calculated thus: a/b=(a+b)/a=1.6180339887498948420 . . . (infinite number). The Golden Spiral has the characteristic such that for every quarter turn (90° or 2π in radians), the distance from the center of the spiral increases by the golden ratio Φ=1.6180. A Golden Curve is a section of a Golden Spiral. This proportion is found in various parts of a normal, healthy human body.

With its three-dimensional contours, the invention is designed to ergonomically support the human seated pelvis. A unique aspect is that the perineum of a person will rest on a raised area, the ridge of which is in the shape of a convex Golden Curve. Similarly, the tailbone of a person will rest high on an area that has the shape of a concave Golden Curve.

The mathematical design of the exercise support cushion allows it to be tailored proportionally for differently sized people.

The contour of the side width edges of the cushion can be varied without the cushion losing the unique Golden Ratio surface curvatures.

The exercise support cushion may incorporate inside of it different materials: far-infrared material, magnets, heating elements, pressure sensors, and other electronic devices.

For thin persons, a thin layer of softer material can be layered on top of the exercise support cushion to make sitting upon it more comfortable.

The support cushion may be placed on a chair, a bench, the floor or the unique top surface contours of the support cushion may be incorporated within larger seats, chairs or other devices that contain seats.

### MODE OF OPERATION

The various uses of the ergonomic support seat cushion can be for any combination of aligning, balancing, stretching, strengthening, self-massaging, meditating, and/or developing proprioceptive skills. The optional far-infrared material, magnets or heating elements can warm and/or activate the body tissues for greater circulation and flexibility of stretching. Pressure sensors and other electronic devices can be used to give feedback and correction. A top layer of softer material can be used to increase the sitting comfort.

The weight and/or movements of the person upon the rigid or semi-rigid cushion have the purpose of shifting their Sitz bones, perineum and tailbone to fit more evenly onto the device, shifting the pelvis toward the structure and alignment recommended by the medical field. The change in the pelvic structure involves changes in the ligaments, nerves and muscles. The medical field has shown that a misaligned pelvis negatively affects posture, spinal alignment, and from there, the major joints of the body and the muscle trains of the entire body.

The contour of the side width has variations with having the purposes of providing optimal comfort and offering greater portability.

Exercises can be performed while sitting on the support cushion seat, with the purpose of releasing tightnesses, strengthening weak muscles, and pressing upon myofascial trigger points and acupoints in the pelvis and hamstrings. Additionally, a form of self-massage can also be achieved by repeatedly shifting the body weight to change the pressure against the unique contours of the support cushion.

During exercises or during stillness, the pressures of the body weight against the perineum and tailbone can be used as focal points of mental attention.

1. A support seat cushion comprising:
A convex bump on the front portion of the centerline of the top surface of said support seat cushion, the ridge of said bump being designed in accordance with a Golden Curve, and said bump being designed into said support seat cushion such that the bump is situated at a human user's perineum;
A raised concave edge on the centerline of the top surface of said support seat cushion that is opposite the said bump and designed in accordance with a Golden Curve, and being designed such that said raised concave edge is situated at a human user's tailbone.
Cushion of claim 1 is incorporated into a chair
Cushion of claim 1 is incorporated into a car seat
Cushion of claim 1 is incorporated into a wheelchair
Cushion of claim 1 is incorporated into a bench
Cushion of claim 1 is incorporated into a truck seat
Cushion of claim 1 is incorporated into a tractor seat
Cushion of claim 1 is incorporated into a sofa
Cushion of claim 1 is incorporated into a meditation seat
